(19) United States
(12) Patent Application Publication
(10) Pub. No.: US 2018/0275422 A1
(43) Pub. Date: Sep. 27, 2018

(54) SPECTACLES

(71) Applicant: HOYA LENS THAILAND LTD., Prachatipat, Thanyaburi, Pathumthani (TH)

(72) Inventor: Yukihiro IZUMITANI, Tokyo (JP)

(73) Assignee: HOYA LENS THAILAND LTD., Prachatipat, Thanyaburi, Pathumthani (TH)

(21) Appl. No.: 15/755,047

(22) PCT Filed: Aug. 25, 2016
(86) PCT No.: PCT/JP2016/074847

§ 371 Date: Feb. 23, 2018

(30) Foreign Application Priority Data
Aug. 28, 2015 (JP) 2015-169659

(51) Int. Cl. G02C 1/02; G02C 5/14

(52) U.S. Cl. CPC G02C 1/02; G02C 5/146

(57) ABSTRACT

Spectacles of a rimless type that are not marred in appearance or subjected to any field-of-view interference but are easily processed. The spectacles include lenses and endpieces. A notched section is formed in each lens, an opening of the notched section is formed in a projected surface (front surface) of the lens, an end of each endpiece is inserted into the notched section, a projection that is a part of the end is fitted in the opening, the notched section is filled with an adhesive, and the maximum diameter of the end is larger than the thickness of the projection.

### TECHNICAL FIELD

The present invention relates to spectacles, and more particularly to a structure for holding the lenses of spectacles.

### BACKGROUND ART

Spectacles of which lenses are held by components other than rims are known. For example, Japanese Utility Model Application Publication No. H07-32620 (PTL 1) discloses “spectacles that support lenses by spectacle component other than rims, wherein the cracking of the lenses is hardly generated, and the design and the material to be used are highly flexible” (see Abstract).

### CITATION LIST

### Patent Literature

[PTL 1] Japanese Utility Model Application Publication No. H07-32620

### SUMMARY OF INVENTION

### Technical Problem

However, according to the technique disclosed in PTL 1, the attaching member must have a shape that can be fitted into the “notched section widening toward the end”, hence the root part of the attaching member is naturally narrower than the widened tip part. The root part, however, requires sufficient strength to support the temple and the like that are connected to the attaching member, which means that the root part requires at least a predetermined thickness. Then the widened part must be even wider than the thickness of the root part, and the notched section of the lens must be large too. As a result, the field of view may be decreased, and the aesthetics of the spectacles may diminish. Further, the processing to form the notched section widening toward the end is not easy either. Furthermore, the attaching members of the spectacles using this technique are very weak to the force in a direction parallel with the grooves, and easily detach. Additionally, in the case of the example depicted in FIG. 4 to FIG. 8 of Japanese Utility Model Application Publication No. H07-32620, the attaching member protrudes from the concave surface of each lens, which makes it difficult to wipe the lens. Therefore a technique of not narrowing the field of view is required. A technique to maintain aesthetics of the spectacles is also required. Further, a technique to make the processing easier is required. A technique to make it difficult for the attaching member to detach is also required. And a technique of making it easier to wipe lenses is required.

With the foregoing problems in view, an object of the present invention is to provide spectacles with which the field of view is not narrowed by wearing the spectacles. Another object is to provide spectacles of which aesthetics is maintained. Another object is to provide spectacles of which processing is easy. Another object is to provide spectacles which makes it difficult for the attaching member to detach. Still another object is to provide spectacles of which lenses can be easily wiped.

### Solution to Problem

Spectacles according to an embodiment include: lenses; endpieces that are attached to the lenses on the ear sides; and temples that are attached to the endpieces. An ear-side opening that receives insertion of the endpiece is formed on the side face of an ear-side periphery of each lens toward the center of the lens. A part of the endpiece includes a projection. A groove that receives insertion of the projection is formed between at least one of a concave surface and a convex surface of the lens and the ear-side opening. The groove is connected to the side face. The width of the ear-side opening is larger than the width of the groove. A part of the endpiece is inserted into the ear-side opening. The projection of the endpiece is inserted into the groove. The opening or the groove is filled with adhesive.

It is preferable that the spectacles further include a bridge to hold the other end of each of the lenses. A part of each end of the bridge includes a projection. A nose-side opening that receives insertion of a part of the bridge is formed on the side face of a nose-side periphery of each lens toward the center of the lens from the side face. The width of the nose-side opening is larger than the width of a groove formed in the nose-side opening.

It is preferable that at least one of the two lenses of the spectacles is held by the endpiece and the bridge.

It is preferable that the cross-section of the ear-side opening includes an arc.

It is preferable that the cross-sectional shape of the ear-side opening is a polygon.

It is preferable that the cross-section of the nose-side opening includes an arc.

It is preferable that the nose-side opening is formed only on one of the concave surface and the convex surface of the lens.

It is preferable that a nose-side opening that receives insertion of a bridge supporting the lens is formed on the side face of a nose-side periphery of the lens toward the center of the lens, and a part of the bridge includes a projection. A groove that receives insertion of the projection of the bridge is formed between at least one of the concave surface and the convex surface of the lens and the nose-side opening. The groove is connected to the side face of the nose-side periphery. The width of the nose-side opening is larger than the width of the groove into which the projection of the bridge is inserted. A part of the bridge is inserted into the nose-side opening. The projection of the bridge is inserted into the groove. The opening or the groove is filled with adhesive.

It is preferable that the length of the projection is shorter than that of the groove.

According to an aspect of the spectacles of this embodiment, the field of view is not narrowed when wearing the spectacles. According to another aspect, the aesthetics of the spectacles is maintained. According to another aspect, the lens can be easily processed. According to another aspect, attaching members of the spectacles becomes difficult to detach. According to still another aspect, the lens can be easily wiped.

The above and other objects, features, aspects and advantages of the present invention will be clarified by the following detailed description of the invention, which can be understood with reference to the accompanying drawings.

### BRIEF DESCRIPTION OF DRAWINGS

FIG. 1 is an external view of a part of the spectacles 100.

FIG. 2 is a diagram depicting a part of the spectacles 100.

FIG. 3 is a diagram depicting an area around the bridge 300 of the spectacles 100.

FIG. 4 shows a notched section according to an aspect.

FIG. 5 shows a notched section according to another aspect.

FIG. 6 shows a notched section according to another aspect.

FIG. 7 is a diagram depicting a state of the notched section 110 viewed from one side of the lens 140.

FIG. 8 is a cross-sectional view depicting a state when the end 820 of the endpiece is inserted into the notched section 810 according to another aspect.

FIG. 9 is a cross-sectional view depicting a state when the end 920 of the endpiece is inserted into the notched section 910 according to another aspect.

FIG. 10 is a cross-sectional view depicting a state when the end 1020 of the endpiece is inserted into the notched section 1010 according to another aspect.

FIG. 11 is a cross-sectional view depicting a state when the end 1120 of the endpiece 1110 is inserted into the notched section of the lens 1100.

### DESCRIPTION OF EMBODIMENT

An embodiment of the present invention will be described with reference to the drawings. In the following description, same components are denoted with same reference signs. The components denoted with the same reference signs have same names and same functions. Therefore a redundant detailed description of these components is not repeated.

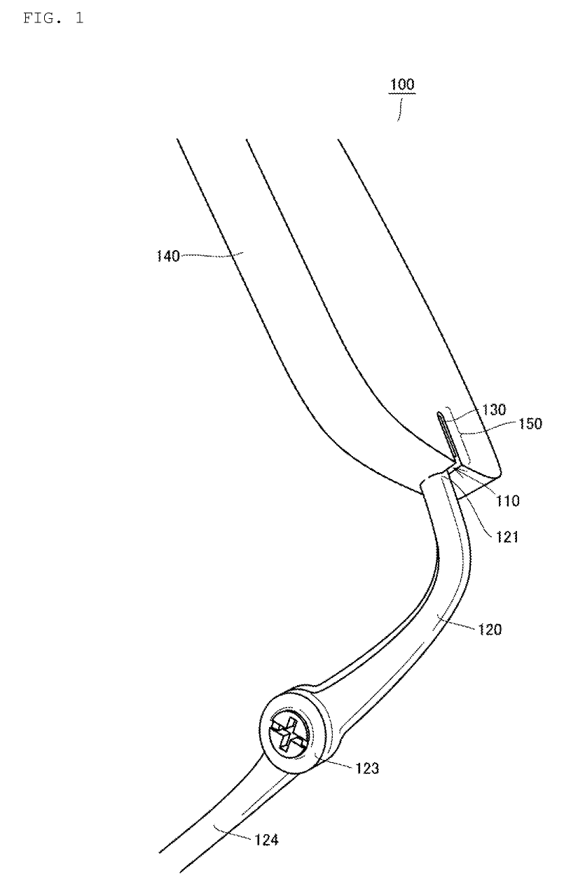

The configuration of the spectacles 100 according to this embodiment will be described with reference to FIG. 1. FIG. 1 is an external view depicting a part of the spectacles 100.

The spectacles 100 include a lens 140 for the right eye, an endpiece 120, a hinge 123 and a temple 124. The spectacles 100 are rimless type spectacles, for example. Here at least one lens, out of two lenses of the spectacles 100, is, a rimless. A notched section 110 is formed on an end of each lens 140 of the spectacles 100.

The notched section 110 has an approximately constant width from the edge of the lens 140 toward the center of the lens. The notched section 110 is configured so that an opening 150 exists on a convex surface (front side) of the lens 140. According to an aspect of the invention, the notched section 110 is filled with adhesive (not illustrated), and an end 121 of the endpiece 120 is inserted into the notched section 110. The adhesive is colorless and transparent, for example, but may be colored. To ensure the field of view, a transparent adhesive is preferable. Epoxy resin, for example, may be used for the adhesive, but the type of adhesive is not limited to this.

The endpiece 120 is configured so as to bend toward the face of the user wearing the spectacles 100. A projection 130 is formed on one end 121 which supports the lens 140, out of both ends of the endpiece 120.

The projection 130 is fitted into the opening 150. The projection 130 is formed by cutting the material of the endpiece 120. According to another aspect of the invention, the projection 130 may be incorporated with the end 121. The hinge 123 is attached on the other end of the endpiece.

The hinge 123 is configured such that the temple 124 can be freely folded inward with respect to the endpiece 120. According to another aspect of the invention, the endpiece 120 and the temple 124 may be integrated as a support member of the lens 140.

According to this embodiment, the thickness (in the front-back direction) of the inserting portion of the end 121 is thinner than the thickness of the lens 140. In other words, the length of the longest portion of the inserting portion of the end 121 is longer than the length of the opening 150 in the thickness direction of the lens 140. Therefore the tip of the projection 130 does not come to a position above the convex surface of the lens 140. Thereby the projected portion does not appear on the surface of the lens 140.

The gap generated in the opening 150 by this end is filled with colorless and transparent adhesive, for example. According to an aspect of the invention, the surface of the adhesive is smooth, and constitutes a part of the convex surface of the lens such that the step difference generated by the opening on the convex surface of the lens 140 disappears. The end 121 and the projection 130 are fixed to the lens 140 by adhesive, hence the end 121 does not easily detach from the notched section 110. Further, in the rimless type spectacles 100, rigidity of the attached portion between the endpiece 120 and the lens 140 improves.

According to the spectacles 100 of this embodiment, the length (height) of the projection 130 is shorter than the length of the groove in the opening 150, hence the tip of the projection 130 does not appear on the surface of the lens 140. Therefore it can be prevented that aesthetics of the spectacles 100 is diminished by the projection 130.

The length of the projection 130 is shorter than the length of the groove, and when the length of the groove is the sum of the length of the projection 130 and the length from the tip of the projection 130 to the surface of the lens 140 (that is, the height of the gap formed in the opening 150 after the end 121 of the endpiece 120 is inserted), it is preferable that the length of the projection 130 is ⅘ of the length of the groove, for example. It is more preferable that this length is ⅗ of the length of the groove, ½ is even more preferable, and ⅓ is ideal.

The relationship between the length of the projection 130 and the height of the gap can be specified to maintain a gap which is large enough to inject the adhesive, so that the adhesive filled into the gap does not separate while the spectacles 100 are worn.

Since no portion is projected from the surface of the lens 140, the lens 140 can be easily polished or wiped, reducing risk of snags. As a result, maintenance of the spectacles 100 becomes easier.

After the end 121 of the endpiece 120 is inserted into the opening 150 of the lens 140, the resin is injected (potting), hence the endpiece 120 does not detach easily from the lens 140. This means that durability of the spectacles 100 can improve.

The configuration around the lens for the left eye is the same as the configuration around the lens 140 for the right eye illustrated in FIG. 1. Therefore redundant description is omitted.

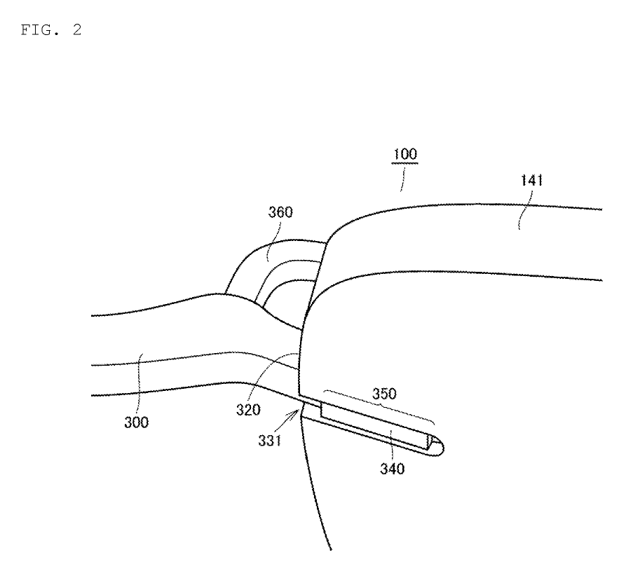

The configuration of the spectacles 100 will be further described with reference to FIG. 2. FIG. 2 is a diagram depicting a part of the spectacles 100. According to an aspect of the invention, the spectacles 100 includes a lens 141 for the left eye and a bridge 300. Nose pads 360 are formed on the bridge 300.

A notched section 331 is formed on the lens 141. The notched section 331 has an approximately constant width from the edge of the lens 141 toward the center of the lens 141. An end 320 of the bridge 300 is inserted into the notched section 331. A projection 340 is formed on a part of the side face of the end 320. The projection 340 is fitted into an opening 350 of the notched section 331 on the convex surface side (front side) of the lens 141. The degree of the fit is not especially limited, and the fitting may be either tight or loose.

To be more specific, the cross-sectional shape of the notched section 331 corresponds to the cross-sectional shape of the end 320. In other words, the inner contour of the notched section 331 is at least larger than the contour of the end 320. Thereby the end 320 is smoothly inserted into the notched section 331. In order to prevent the bridge 300 from rotating around the end 320 at this time, the projection 340, to prevent rotation, is formed on a part of the end 320.

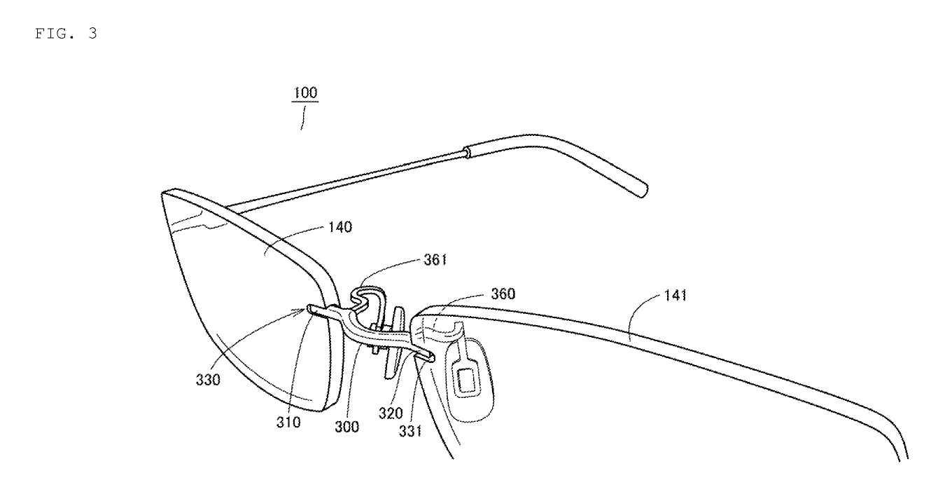

The configuration of the spectacles 100 will be further described with reference to FIG. 3. FIG. 3 is a diagram depicting an area around the bridge 300 of the spectacles 100. The spectacles 100 are rimless type spectacles. Nose pads 360 and 361 are formed on the bridge 300. The ends 310 and 320 of the bridge 300 respectively, which hold the left and right lenses 140 and 141, are inserted into the notched sections 330 and 331 formed in the lenses 140 and 141. At the bridge 300, similarly to the configuration of the endpiece 120 of the lens 140, the notched section 330 is formed on the convex surface (front surface) side of the lens 140 toward the inside (rear surface). A projection is formed in a part of the end 310 of the bridge 300, similarly to the projection 130 illustrated in FIG. 1.

In the notched section 330 of the lens 140, a groove, to which the projection is inserted, is formed to prevent rotation of the end 310 of the bridge 300. The notched section 330 is filled with adhesive, and the end 310 of the bridge is inserted into the notched section 330. Similarly to the case of attaching the endpiece 120, the adhesive may be colorless and transparent, for example, but may be colored. Transparence is preferable in terms of not obstructing the field of view.

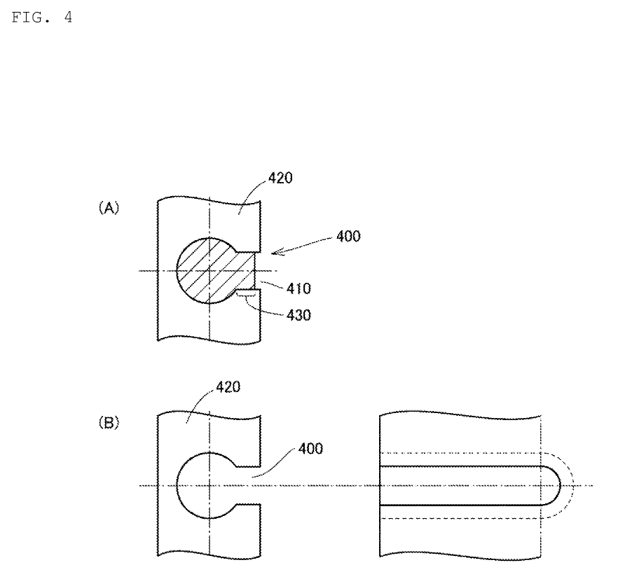

The notched section according to this embodiment will be described with reference to FIG. 4 to FIG. 10. FIG. 4 shows diagrams depicting a notched section according to an embodiment of the invention. As illustrated in the cross-sectional view in FIG. 4A, the notched section 400 is configured as round key hole-shaped, with a projection according to an aspect of the invention. A groove 410, to which a projection 430 is inserted, penetrates the lens 420 toward the convex surface side. The projection 430 prevents the rotation of the support member of the spectacles, including the endpiece 120.

As illustrated in the cross-sectional view in FIG. 4B, the notched section 400 is formed by moving an end mill, of which tip is ball-shaped, from one surface (e.g. either convex surface or convex surface) of the lens 420 toward inside the lens.

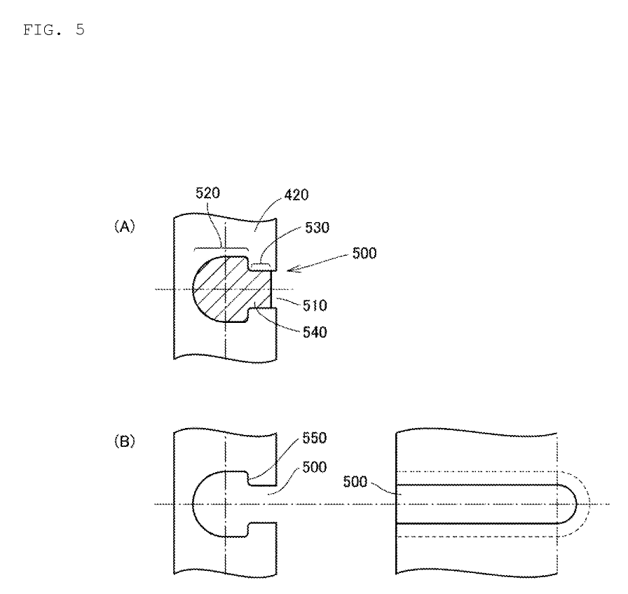

FIG. 5 shows diagrams depicting a notched section according to another aspect of the invention. As illustrated in the cross-sectional view in FIG. 5A, the notched section 500 is configured to have a cross-section constituted by a semicircular part 520 and a rectangular part 530, to which a groove 510, where a projection 540 is inserted, is added. Similarly to the case of the cross-sectional view in FIG. 4A, the projection 540 penetrates the lens 420 toward the convex surface side. The projection 540 prevents rotation of the support member of the spectacles, including the endpiece 120, by contacting the side face of the opening facing the side face of the rectangular part 530.

As illustrated in the cross-sectional view in FIG. 5B, the notched section 500 is formed by moving an end mill, which has an angular tip, from one surface (e.g. either convex surface or concave surface) of the lens 420 toward inside the lens. As illustrated in the cross-sectional view in FIG. 5A, the load is supported by this surface 550 when the notched section is widened by the endpiece. If the height of the groove 510 formed in the notched section 500 is larger than the height of the projection 540, a gap is formed at the tip of the notched section 500. The gap is filled with adhesive so that the end and the lens 420 are firmly bonded.

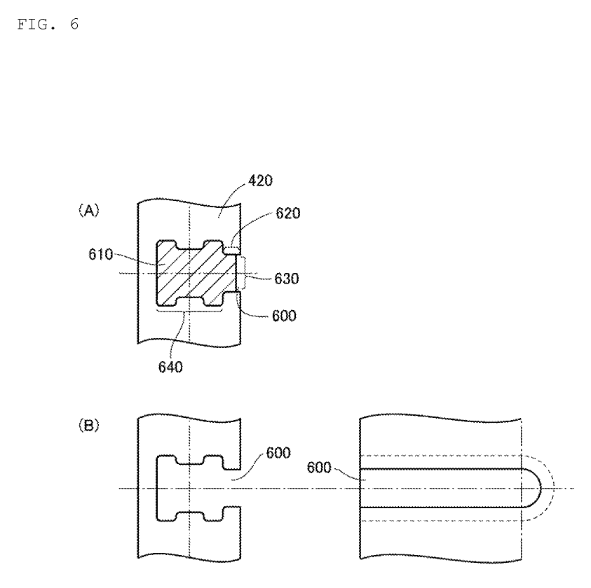

FIG. 6 shows diagrams depicting a notched section according to another aspect of the invention. As illustrated in the cross-sectional view in FIG. 6A, the notched section 600 is configured to have a shape of an end 610 having convex/concave portions to which a projection 620 is added. Similarly to the case of the cross-sectional view in FIG. 4A, an opening 630, to which the projection 620 is inserted, penetrates the lens 420 toward the convex source of the lens 420. The projection 620 prevents rotation of the support member of the spectacles, including the endpiece.

As illustrated in the cross-sectional view in FIG. 6B, the notched section 600 is formed by moving an end mill, which has an angular tip and a trough, from one surface (e.g. either convex surface or concave surface) of the lens 420 toward inside the lens 420. Even if a force to expand the notched section 600 is applied by the endpiece (component), the surface included in the convex/concave section 640 (peripheral surfaces) formed on the end 610 of the notched section 600 can support the load applied by this expansion. Thereby the bonded state between the lens and the endpiece can be maintained.

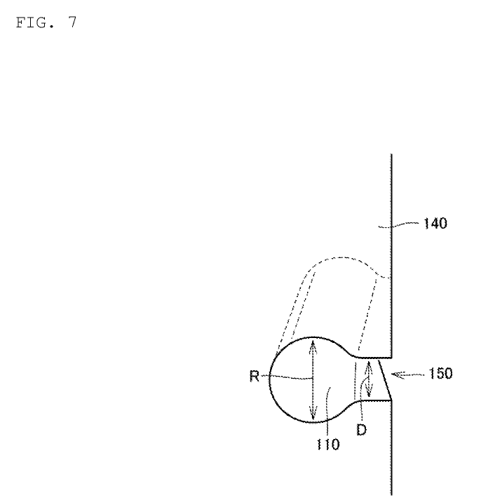

FIG. 7 is a diagram depicting the state when the notched section 110 is viewed from one surface of the lens 140. AS illustrated in FIG. 7, the cross-section of the notched section 110 according to an aspect of the invention is constituted by a combination of an arc and lines. At this time, the diameter R of the arc is preferably larger than the width D of the groove.

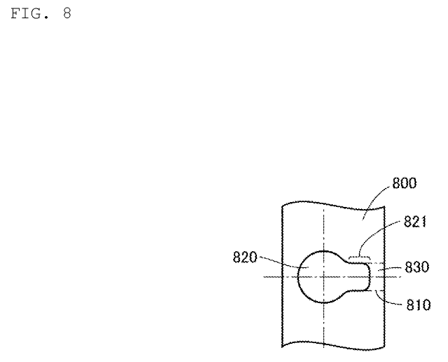

The structure of the notched section will be further described with reference to FIG. 8 to FIG. 10. FIG. 8 is a cross-sectional view depicting the state when an end 820 of the endpiece is inserted into the notched section 810 according to another aspect of the invention.

As illustrated in FIG. 8, the notched section 810 is formed in a lens 800 according to this aspect. The end 820 of the endpiece is inserted into the notched section 810. The cross-section of the end 820 includes an arc portion and a projection 821. The diameter of the arc portion is larger than the width of the projection 821. The length from the center of the arc portion to the tip of the projection 821 is larger than the diameter of the arc portion.

This means that the rotation of the end 820 is stopped by the projection 821. In other words, if the cross-section of the end 820 had only the arc portion, the endpiece may rotate. However, the projection 821 can prevent rotation of the endpiece. According to another aspect of the invention, a gap 830 between the notched section 810 and the end 820 is filled with adhesive. The adhesive is preferably transparent. The color of the adhesive is not especially limited, but may be colorless or colored in accordance with the color of the lens 800 or the end 820.

The opening of the notched section 810 may be formed in either the concave surface or the concave surface of the lens 800. This means that the coating surface of the adhesive that fills the gap 830 generated after the end 820 is inserted could be either on the convex surface or the concave surface of the lens 800. In this case, it is preferable that the opening is filled with adhesive so that the surface of the adhesive becomes approximately the same as a part of the convex surface or the concave surface. The position of the notched section 810 in the lens 800 may be at the center position of the line connecting the top and bottom of the lens 800, or may be above or below the center position.

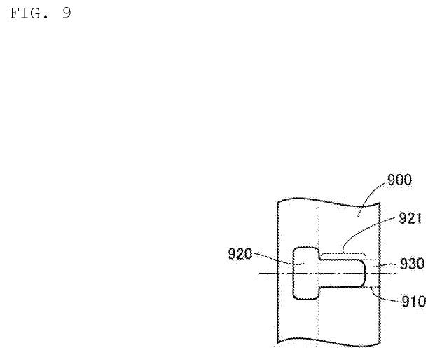

FIG. 9 is a cross-sectional view depicting the state when an end 920 of an endpiece is inserted into a notched section 910 according to another aspect of the invention. As illustrated in FIG. 9, the notched section 910 is formed in a lens 900 according to this aspect. The end 920 of the endpiece is inserted into the notched section 910. The cross-section of the end 920 is approximately T-shaped. The T-shaped notched section 910 is formed by moving an end mill, having a microscopic diameter, in a T-shape, for example. According to another aspect of the invention, a gap 930 between the notched section 910 and the end 920 is filled with adhesive. The adhesive is preferably transparent. The color of the adhesive is not especially limited, but may be colorless or colored in accordance with the color of the lens 900 or the end 920.

The opening of the notched section 910 may be formed in either the convex surface or the concave surface of the lens 900. This means that the coating surface of the adhesive that fills the gap 930 generated after the end 920 is inserted could be either on the convex surface or on the concave surface of the lens 900. In this case, it is preferable that the notched section 910 is filled with the adhesive, so that the surface of the adhesive becomes approximately the same as a part of the convex surface or the concave surface.

The position of the notched section 910 in the lens 900 may be at the center position of the line connecting the top and bottom of the lens 900, or may be above or below the center position.

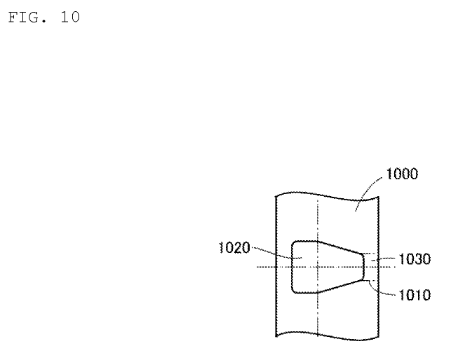

FIG. 10 is a cross-sectional view depicting the state when an end 1020 of an endpiece is inserted into a notched section 1010 according to still another aspect of the invention. As illustrated in FIG. 10, the notched section 1010 is formed in a lens 1000 according to this aspect. The end 1020 of the endpiece is inserted into the notched section 1010. The cross-section of the end 1020 is approximately trapezoidal. The trapezoidal notched section 1010 is formed by an end mill having a microscopic diameter, for example. Further, according to another aspect of the invention, a gap 1030 between the notched section 1010 and the end 1020 is filled with adhesive. The adhesive is preferably transparent. The color of the adhesive is not especially limited, but may be colorless or colored in accordance with the color of the lens 1000 or the end 1020.

The opening of the notched section 1010 may be formed in either the convex surface or the concave surface of the lens 1000. The position of the notched section 1010 in the lens 1000 may be at the center position of the line connecting the top and bottom of the lens 1000, or may be above or below the center position.

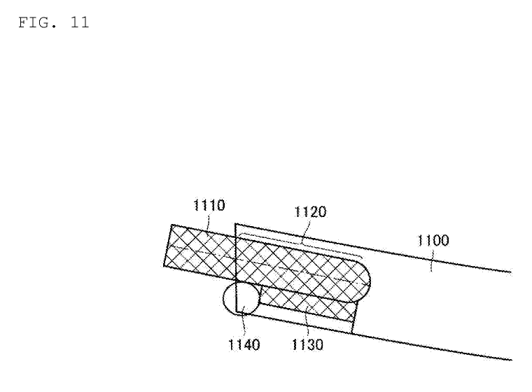

Fixing a component with adhesive according to this embodiment will be described with reference to FIG. 11. FIG. 11 is a cross-sectional view depicting a state when an end 1120 of an endpiece 1110 is inserted into a notched section of a lens 1100. The end 1120 of the endpiece 1110 and a projection 1130 are inserted into the notched section. A gap 1140 between the notched section and the projection 1130 is filled with adhesive. The adhesive is preferably transparent. The color of the adhesive is not especially limited, but may be colorless or colored in accordance with the color of the lens 1100 or the end 1120.

The adhesive is filled and solidified so as to prevent the projection 1130 from detaching. The solidified portion is not damaged by a force that is applied during normal use of the spectacles, including the lens 1100. Therefore detaching of the endpiece 1110 from the lens 1100 in normal use can be prevented. If the opening of the notched section is formed on the concave surface (rear surface), this opening is not seen when viewed from the front side (convex surface side) of the user of the spectacles, which means that aesthetics of the spectacles improves.

### Summary of Embodiment

As described above, according to this embodiment, the opening or the groove can be made small by decreasing the thickness of the component (e.g. endpiece), hence load on the cutter to form this opening can be decreased. For example, even if the cutter is thin, this cutter does not easily break. Furthermore, a decrease in the thickness of the component improves aesthetics of the spectacles using such a component.

Furthermore, the end of the component can be embedded in the lens, which makes it easier to wipe the lens surface off. The opening of the notched section is formed in either the concave surface or the convex surface of the lens, and is filled with adhesive when necessary. By this configuration, locations of possible contamination can be minimized, and dirt on the lens can be prevented.

Moreover, edge thickness can be decreased to a minimum, which in turn makes the spectacles lighter and more comfortable to wear. The aspects of the spectacles as a whole is also improved.

According to another aspect of the invention, the configuration of the component and the configuration of the cutter to process the groove can be simplified by making the shape of the component simpler (e.g. cylindrical shape, T-shape sectional shape, trapezoidal sectional shape) and thereby manufacturing becomes easier. As a result, precision of the components and grooves improve, and the rigidity of the spectacles as a whole can be improved.

The spectacles according to an example of the invention includes: the lens 140; the endpieces 120 that are attached to the lenses 140 on the ear sides; and the temples 124 that are attached to the endpieces 120. The opening 150 that receives insertion of the endpiece 120 is formed on the side face of the ear side periphery of each lens 140 toward the center of the lens 140. A part of the endpiece 120 includes the projection 130. The groove that receives insertion of the projection 130 is formed between at least one of the concave surface and the convex surface of the lens 140 and the ear-side opening 150. The groove is connected to the side face. The width of the ear-side opening 150 is larger than the width of the groove. A part of the endpiece 120 is inserted into the ear-side opening. The projection 130 of the endpiece 120 is inserted into the groove. According to this configuration, the insertion portion of the endpiece 120 need not be thick, therefore the field of view of the wearer of the spectacles is not obstructed.

In the spectacles according to another example, the opening 150 or the groove is filled with adhesive. If this configuration is used, the endpiece 120 does not easily detach from the lens 140.

The spectacles according to another example further includes a bridge 300 to hold the other end (nose side) of the lens 141. A part of each end of the bridge 300 includes a projection 340. The opening 350 that receives insertion of a part of the bridge 300 is formed on the side face of the nose-side periphery of each lens 141 toward the center of the lens 141. The width of the nose-side opening 350 is larger than the width of the groove formed in the opening 350. According to this configuration, the end portion of the bridge 300 need not be thick, similarly to the insertion portion of the endpiece on the ear side, hence the field of view of the user of the spectacles is unobstructed.

In the spectacles according to another example, at least one lens 140 of the two lenses of the spectacles is held by the endpiece 120 and the bridge 300. According to this configuration, the insertion portions of the endpiece 120 and the bridge 300 to each lens 140 need not be thick, therefore the field of view of the lens 140 is unobstructed.

In the spectacles according to another example, the cross-section of the ear-side opening 150 includes an arc, in addition to the configuration according to any of the above examples. According to this configuration, the end 121 of the endpiece 120 can be more easily inserted into the opening 150. Further, concentration of the load on one location can be prevented, since the contact surface between the end 121 and the side face of the opening 150 can be increased. As a result, wearing down of the endpiece 120 can be minimized.

In the spectacles according to another embodiment, the cross-sectional shape of the ear-side opening 150 is a polygon, in addition to the configuration according to any of the above examples. According to this configuration, concentration of load on one location can be prevented, since the contact surface between the end 121 and the side face of the opening 150 can be increased. As a result, wearing down of the endpiece 120 can be minimized.

In the spectacles according to another example, the cross-section of the nose-side opening 350 includes an arc, in addition to the configuration according to any of the above examples. According to this configuration, the end 320 can be more easily inserted into the opening 350. Further, concentration of load on one location can be prevented, since the contact surface between the end 320 and the side face of the opening 350 can be increased. As a result, wearing down of the bridge 300 can be minimized.

In the spectacles according to another example, the nose-side opening 350 is formed only on one of the concave surface and the convex surface of the lens 141. According to this configuration, the bridge 300 can support the lens 141 while maintaining the strength of the side face of the lens 141.

In the spectacles according to another example, the length of the projection is shorter than the groove. According to this configuration, the projection does not appear on the surface of the lens, hence a finger or cloth is not snagged by the projection. As a result, aesthetics of the spectacles can be maintained. In other aspect of the invention, good maintainability of the spectacles can be sustained.

The embodiment disclosed above is merely an example of all aspect, and is not intended to limit the present invention. The scope of the invention is indicated not by the above description, but by the Claims, and includes meanings equivalent to the Claims and all modifications within the scope therein.

### REFERENCE SIGNS LIST

100 Spectacles
110, 330, 331, 400, 500, 600, 810, 910, 1010 Notched section
120, 1110 Endpiece
121, 310, 320, 610, 820, 920, 1020, 1120 End
123 Hinge
124 Temple
130, 340, 430, 540, 620, 821, 921, 1130 Projection
140, 141, 420, 800, 900, 1000, 1100 Lens
150, 350, 630 Opening
300 Bridge
360, 361 Nose pad
410, 510 Groove
520 Semicircular part
530 Rectangular part
550 Surface
640 Concave/convex section
830, 930, 1030, 1140 Gap

1-9. (canceled)

10. Spectacles, comprising:
lenses;
endpieces that are attached to the lenses on the ear sides; and
temples that are attached to the endpieces, wherein
an ear-side notched section that receives insertion of the endpiece is formed on the ear-side edge of each lens toward the center of the lens, and the endpiece includes a projection,
the ear-side notched section includes an ear-side opening that receives insertion of the projection and that is connected to the concave surface or the convex surface of the lens,
the ear-side opening is connected to the ear-side edge,
the width of a portion of the ear-side notched section other than the ear-side opening is larger than the width of the ear-side opening,
the endpiece is inserted into the ear-side notched section,
the projection of the endpiece is inserted into the ear-side opening, and
the ear-side notched section is filled with adhesive.

11. The spectacles according to claim 10, further comprising a bridge to hold the other end of each of the lenses, wherein
a part of each end of the bridge includes a projection,
a nose-side notched section that receives insertion of a part of the bridge is formed on the nose-side edge of each lens from the nose-side edge toward the center of the lens,
the nose-side notched section includes a nose-side opening which is connected to the concave surface or the convex surface of the lens, and
the width of a portion of the nose-side notched section other than the nose-side opening is larger than the width of the nose-side opening.

12. The spectacles according to claim 11, wherein
at least one of the two lenses of the spectacles is held by the endpiece and the bridge.

13. The spectacles according to claim 10, wherein
the cross-section of the portion of the ear-side notched section other than the ear-side opening includes an arc.

14. The spectacles according to claim 10, wherein
the cross-section of the portion of the ear-side notched section other than the ear-side opening is circular, and the cross-section of the ear-side opening is rectangular.

15. The spectacles according to claim 10, wherein
the cross-sectional shape of the portion of the ear-side notched section other than the ear-side opening is polygonal.

16. The spectacles according to claim 11, wherein
the cross-section of the portion of the nose-side notched section other than the nose-side opening includes an arc.

17. The spectacles according to claim 11, wherein
the nose-side opening is formed only on one of the concave surface and the convex surface of the lens.

18. The spectacles according to claim 11, wherein
the bridge is inserted into the nose-side notched section,
the projection of the bridge is inserted into the nose-side opening, and
the nose-side notched section is filled with adhesive.

19. The spectacles according to claim 10, wherein
the length of the projection of the endpiece is shorter than the length of the ear-side opening in the thickness direction of the lens.

20. A frame of the spectacles according to claim 10, wherein
the frame includes the endpieces and the temples.
